(19) United States
(12) Patent Application Publication
(10) Pub. No.: US 2024/0419849 A1
(43) Pub. Date: Dec. 19, 2024

(54) Design Support Device, Design Support Apparatus Including Design Support Device, and Design Support Method

(71) Applicant: Hitachi, Ltd., Chiyoda-ku, Tokyo (JP)

(72) Inventors: Erika KATAYAMA, Tokyo (JP); Makoto ONODERA, Tokyo (JP); Tatsuya HASEBE, Tokyo (JP)

(21) Appl. No.: 18/703,811

(22) PCT Filed: Oct. 28, 2022
(86) PCT No.: PCT/JP2022/040562

§ 371 Date: Apr. 23, 2024

(30) Foreign Application Priority Data
Jan. 26, 2022 (JP) 2022-010422

(51) Int. Cl. G06F 30/12; G06F 30/20

(52) U.S. Cl. CPC G06F 30/12; G06F 30/20

(57) ABSTRACT

The invention provides a design support device that supports design of a CAD model, the design support device includes: an input unit configured to input the CAD model and a feature value including a shape and a position of the CAD model; a feature value identification unit configured to identify the shape and the position on the CAD model using the feature value received from the input unit; a frequency calculation unit configured to calculate a frequency of the identified shape and the identified position; and an output unit configured to output the frequency distribution calculated by the frequency calculation unit.

### TECHNICAL FIELD

The present invention relates to a design support device, a design support apparatus including the design support device, and a design support method.

### BACKGROUND ART

In the related art, it is known to design a product or the like on a computer using a computer-aided design (CAD) system. The design using CAD is called CAD design.

In the CAD design, it is desirable to consider a design guideline in consideration of manufacturability, such as ease of processing such as drilling and bending and ease of assembly such as welding and screw fastening, which are problems in product design.

Further, in the CAD design, it is desirable to consider a design guideline in consideration of maintainability such as ease of inspection and ease of access to jigs, which are problems during product maintenance. These design guidelines may include about several tens of thousands of rules for one product, and are usually checked manually using a check list or the like.

For example, there is a design guideline such as “a hole through which a bolt passes is in a range larger than a bolt diameter by ** mm to a ##mm”. A rule that can be checked on a CAD model from the design guideline is referred to as a determination rule.

Patent Literature 1 discloses a technique for supporting quantification of a threshold value of a feature value included in the determination rule. Patent Literature 1 discloses extracting a feature value including a dimension parameter, a shape characteristic parameter, a number parameter, and an attribute parameter from 3D CAD data which is commercialized and output previously, calculating a statistical value based on the extracted feature value, and performing quantification of a determination rule based on the calculated statistical value.

### CITATION LIST

### Patent Literature

Patent Literature 1: JP2021-2188A

### SUMMARY OF INVENTION

### Technical Problem

However, in Patent Literature 1, since the determination rule is quantified, it is difficult to check the determination rule in which a threshold value is not uniquely determined.

In the design guidelines, there are many determination rules in which the threshold value is not uniquely determined depending on a load condition or an actual operation condition of a product. For example, regarding a thickness of a rib formed by resin molding, the thickness of the rib is thick in a portion where a load is large, and the thickness of the rib is thin in a portion where the load is small. However, it is difficult to define on the CAD all the load conditions that differ depending on positions.

In view of the above problem, an object of the invention is to check on the CAD even for a determination rule in which a threshold value cannot be uniquely defined.

### Solution to Problem

In order to solve the above-described problem, the invention provides a design support device that supports design of a CAD model. The design support device includes: an input unit configured to input the CAD model and a feature value including a shape and a position of the CAD model; a feature value identification unit configured to identify the shape and the position on the CAD model using the feature value received from the input unit; a frequency calculation unit configured to calculate a frequency of the identified shape and the identified position; and an output unit configured to output the frequency distribution calculated by the frequency calculation unit.

### Advantageous Effects of Invention

According to the invention, it is possible to check a violated portion on CAD even for a determination rule in which a threshold value cannot be uniquely defined.

### BRIEF DESCRIPTION OF DRAWINGS

FIG. 1 is a diagram showing a configuration of a design support device according to a first embodiment.

FIG. 2 is a diagram showing a flowchart of the design support device according to the first embodiment.

FIG. 3 is a configuration diagram of a design support apparatus when the design support device according to the first embodiment is mounted on a computer.

FIG. 4 is a diagram showing an input screen according to the first embodiment.

FIG. 5 is a diagram showing an output screen according to the first embodiment.

FIG. 6 is a diagram showing a frequency distribution according to the first embodiment.

FIG. 7 is a diagram showing a shape and a position corresponding to an outlier 1 according to the first embodiment on a CAD model.

FIG. 8 is a diagram showing a shape and a position corresponding to an outlier 2 according to the first embodiment on the CAD model.

FIG. 9 is a diagram showing an output screen according to a second embodiment.

FIG. 10 is a diagram showing a frequency distribution of wall thicknesses and bending R according to the second embodiment.

FIG. 11 is a diagram showing a shape and a position corresponding to an outlier 1002 according to the second embodiment on a CAD model.

FIG. 12 is a diagram showing a configuration of a design support device according to a third embodiment.

FIG. 13 is a diagram showing an output screen according to the third embodiment.

FIG. 14 is a diagram showing a frequency distribution according to the third embodiment.

FIG. 15 is a diagram showing a comparison between a past calculation frequency distribution and a frequency distribution of a CAD model to be checked according to the third embodiment.

FIG. 16 is a diagram showing a shape and a position corresponding to an outlier 1502 according to the third embodiment on a CAD model.

### DESCRIPTION OF EMBODIMENTS

Hereinafter, embodiments of the invention will be described with reference to the drawings.

### First Embodiment

In a first embodiment, an example of a frequency calculation method and a violated portion identification method in the case of one variable to be considered will be described. A method for identifying a violated portion may be automatic or manual.

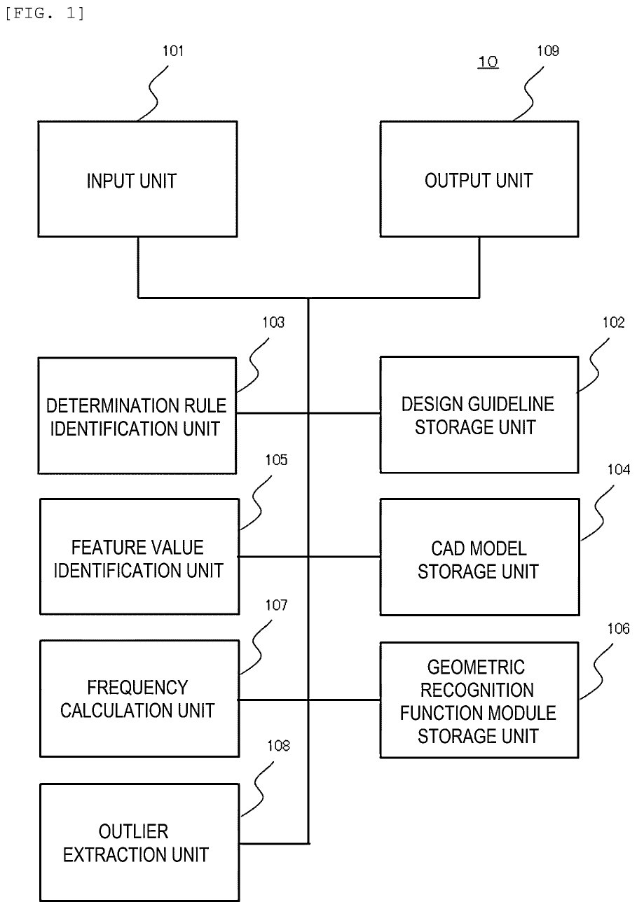

FIG. 1 is a diagram showing a configuration of a design support device according to the first embodiment. In FIG. 1, a design support device 10 includes an input unit 101, a design guideline storage unit 102, a determination rule identification unit 103, a CAD model storage unit 104, a feature value identification unit 105, a geometric recognition function module storage unit 106, a frequency calculation unit 107, an outlier extraction unit 108, and an output unit 109.

The input unit 101 inputs a CAD model to be checked and feature values of a shape and a position of the CAD model.

The design guideline storage unit 102 stores a design guideline. The design guideline includes a rule to be considered during design in usage of a manufacturing apparatus or a tool, a processing limit, and standards such as JIS. For example, the design guideline includes a positional definition from an end portion or a bending to a hole, a dimensional definition of a fillet R, and accessibility of a manufacturing tool.

The determination rule identification unit 103 identifies a determination rule to be verified on the CAD model. The determination rule identification unit 103 includes a portion that identifies an element of the determination rule by a user referring to or taking in the rule in the design guideline, and a portion that identifies the determination rule from the design guidelines accumulated previously based on an input of the user. The determination rule identification unit 103 may display the determination rule to the user via the output unit 109.

The CAD model storage unit 104 includes a CAD model to be checked and a CAD model designed previously.

The feature value identification unit 105 identifies each feature value of a variable applied to a check selected by the user from the feature values of the shapes and the positions included in the CAD model.

The geometric recognition function module storage unit 106 accumulates a group of basic elemental computer-callable procedure functions (hereinafter, referred as common functions). Examples of an accumulation method performed by the geometric recognition function module storage unit 106 include a method for acquiring functions from outside and a method for generating the functions in the geometric recognition function module storage unit 106.

The frequency calculation unit 107 calculates a frequency distribution of the feature values of the shape and position included in the CAD model identified by the feature value identification unit 105. The frequency distribution referred to here indicates, for example, an existence ratio of a certain shape included in the CAD model or a position of the certain shape included in the CAD model.

The outlier extraction unit 108 extracts an outlier from the frequency distribution of feature values of the shape and the position included in the CAD model calculated by the frequency calculation unit 107. The outlier is a candidate of a portion unsuitable for the CAD model to be checked. As a method for extracting the outlier, for example, there is a method for extracting a portion having a low frequency in the frequency distribution. Specifically, for example, there is a method in which the frequency distribution of the feature value is represented by a histogram, and a portion where the frequency of the feature value is low is extracted as the outlier.

As the method for extracting a portion in which the frequency of the feature value is low, for example, a method for setting a threshold value of the frequency and extracting a shape and a position corresponding to a frequency equal to or less than the threshold value is exemplified. The threshold value is a boundary value indicating whether the value is the outlier. Examples of a method for setting the threshold value include a method for setting a lower limit value of the frequency as the threshold value and a method for setting presence or absence of existence as the threshold value. As the method for setting the lower limit value of the frequency as the threshold value, for example, there is a method for setting a frequency of 5% or less as the lower limit value based on a 95% confidence interval. In addition, as the method for setting the presence or absence of the existence as the threshold value, for example, there is a method for setting the presence or absence of a shape for each position in a CAD model designed previously as the threshold value.

The output unit 109 outputs the frequency distribution calculated by the frequency calculation unit 107. By outputting the frequency distribution and indicating the frequency distribution to a designer, the designer can easily know a portion that needs to be corrected in the CAD model. The output unit 109 may output, to the designer, the shape and the position corresponding to the outlier extracted by the outlier extraction unit 108. As an output method, for example, there is a method for outputting the shape and the position identified as the outlier on the CAD model.

From the viewpoint of visibility of the designer, the identified shape and position may be highlighted on the CAD model. In addition, in order to make it easy for the designer to correct the shape and position of the outlier, for example, a violation list or design know-how may also be output. The output unit 109 may output a combination of any of the output methods described above or a combination of all of the output methods described above.

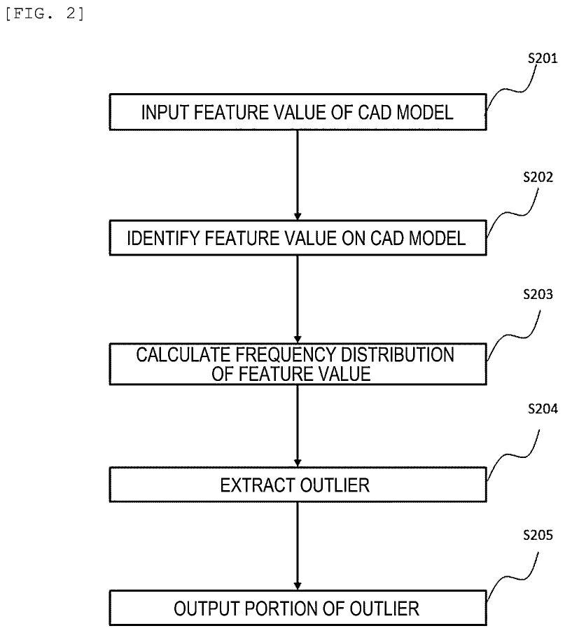

FIG. 2 is a flowchart showing an operation of the first embodiment.

In step S201, the input unit 101 inputs a feature value including a shape and a position of a CAD model to be checked.

In step S202, when the determination rule identification unit 103 selects that the quantification is difficult, the feature value identification unit 105 identifies the feature value of the CAD model used for the check. Before identifying the feature value of the CAD model, the determination rule identification unit 103 may determine in advance whether the quantification of the determination rule related to the input feature value is possible or impossible.

In step S203, the frequency calculation unit 107 calculates a frequency distribution of the shape and the position of the CAD model based on an acquired common function. The frequency calculation unit 107 may calculate the frequency distribution of the shape and the position of the CAD model by referring to a geometric recognition function of the geometric recognition function module storage unit 106.

In step S204, the outlier extraction unit 108 detects a value deviated from the frequency distribution of the feature value using the frequency distribution of the feature value calculated by the frequency calculation unit 107.

In step S205, the output unit 109 outputs a portion of the deviated value detected by the outlier extraction unit 108 onto the CAD model. When the output unit 109 outputs a portion that is deviated, a violation content may be simultaneously output. Here, the portion is a portion including the shape and position of the CAD model.

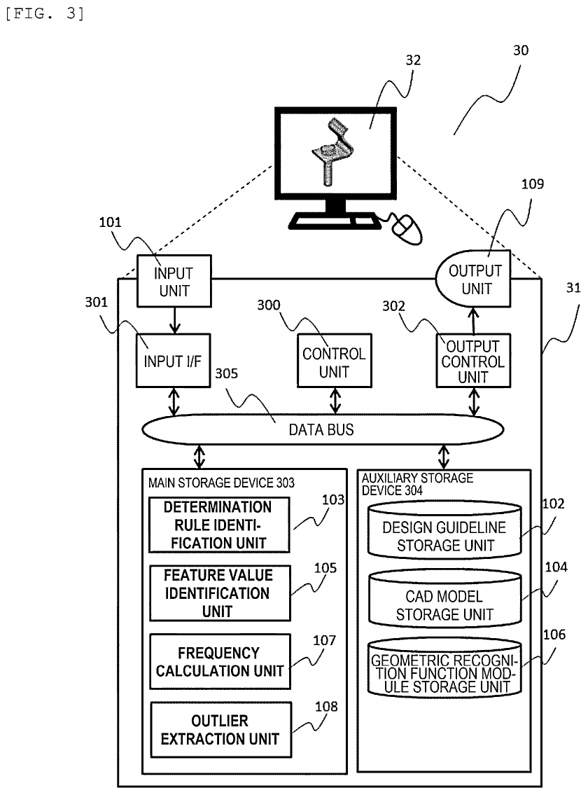

FIG. 3 is a configuration diagram of a design support apparatus 30 when the design support device 10 according to the first embodiment is mounted on a computer.

The design support apparatus 30 includes the input unit 101, the output unit 109, a processing unit 31, and a display unit 32. The display unit 32 displays a setting screen for setting by the user, the frequency distribution calculated by the frequency calculation unit, and the like on a screen of the computer.

The input unit 101 and the output unit 109 provide the user with an operation environment using a graphical user interface (GUI).

The processing unit 31 includes a main storage unit 303 and an auxiliary storage device 304. The processing unit 32 may include an input interface (hereinafter, referred to as an input I/F) 301 that takes in the CAD model or the determination rule received from the input unit 101, and an output control unit 302 that controls the output unit 109. The input I/F 301, the output control unit 302, a control unit 300, the main storage unit 303, and the auxiliary storage unit 304 may be connected to one another via a data bus 305.

The main storage unit 303 includes the determination rule identification unit 103, the feature value identification unit 105, the frequency calculation unit 107, and the outlier extraction unit 108.

The auxiliary storage unit 304 includes the design guideline storage unit 102, the CAD model storage unit 104, and the geometric recognition function module storage unit 106.

A part or all hardware used in the computer of the processing unit 32 may be any of a digital signal processor (DSP), a field programmable gate array (FPGA), and a graphics processing unit (GPU). In addition, a part or all hardware may be arranged in a cloud in a server on a network in a concentrated or distributed manner, and multiple users may perform cooperative work via a network.

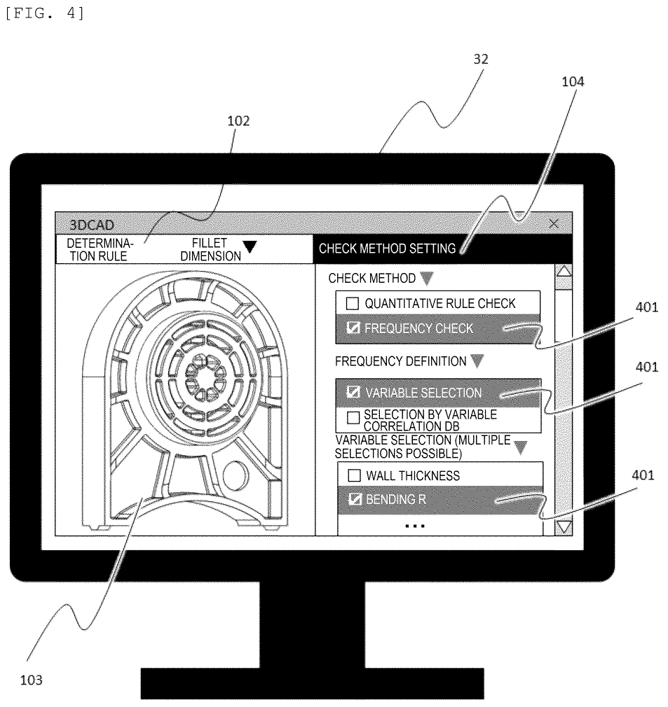

FIG. 4 is a diagram showing an example of an input setting screen according to the first embodiment. The display unit 32 displays the determination rule selected by the determination rule selection unit 103. On a right side of the screen, a setting screen 401 for inputting information necessary for the feature value identification unit 106 to identify a feature value is shown.

In the first embodiment, a frequency check is selected as a check method, a variable is selected as a frequency definition, and a bending fillet R (hereinafter, a “bending R”) is selected as the variable. In response to this input, a calculation function of the bending R may be extracted from the common functions stored in the geometric recognition function module storage unit 107, and a value of the bending R of a surface existing on a 3D CAD model may be calculated. Although the 3D CAD model is used in the first embodiment, the invention is also applicable to a 2D CAD model.

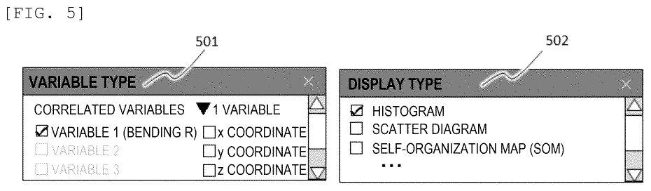

FIG. 5 is a diagram showing an example of an output setting screen according to the first embodiment. Since the variable selected on the setting screen 401 is the bending R, the bending R can be selected on an output variable selection screen 501. Next, a frequency distribution to be output can be selected on a frequency distribution output selection screen 502. Examples of the frequency distribution include a histogram, a scatter diagram, and a self-organization map. The first embodiment is described using the histogram.

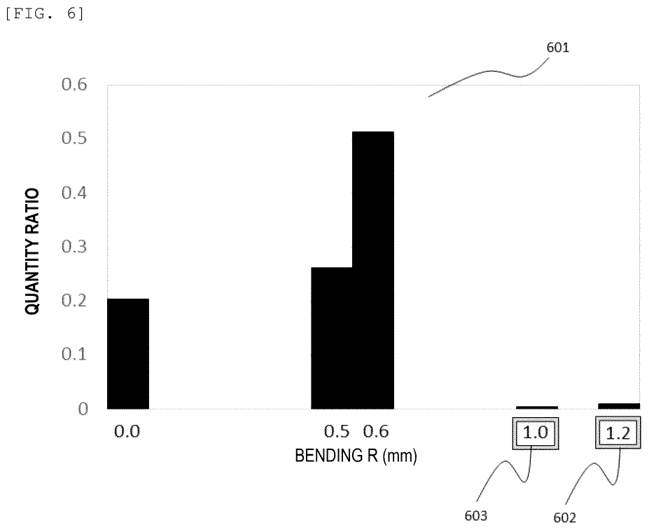

FIG. 6 is a diagram represented by a histogram 601 showing a relationship between the bending R and a quantity ratio of the bending R calculated by the frequency calculation unit 107 in the first embodiment. The frequency calculation unit 107 in the first embodiment calculates a length of the bending R and the quantity ratio of the bending R for each surface, and represents the calculated result in the histogram 601.

Using the histogram 601, the outlier extraction unit 108 may detect the length of the bending R having a threshold value of the quantity ratio of 0.1 or less as a violation site. When detecting the length of the bending R having the threshold value of 0.1 or less as the violation site, the outlier extraction unit 108 extracts an outlier 602 at which the bending R is 1.2 and an outlier 603 at which the bending R is 1.0 as the violated portions. By setting the threshold value, it is possible to automatically extract the violated portion. In addition, there is also a method in which the threshold value is not set, the relationship between the bending R and the quantity ratio calculated by the frequency calculation unit 107 is displayed to the user as the frequency distribution on a histogram or the like, and the user selects the outlier.

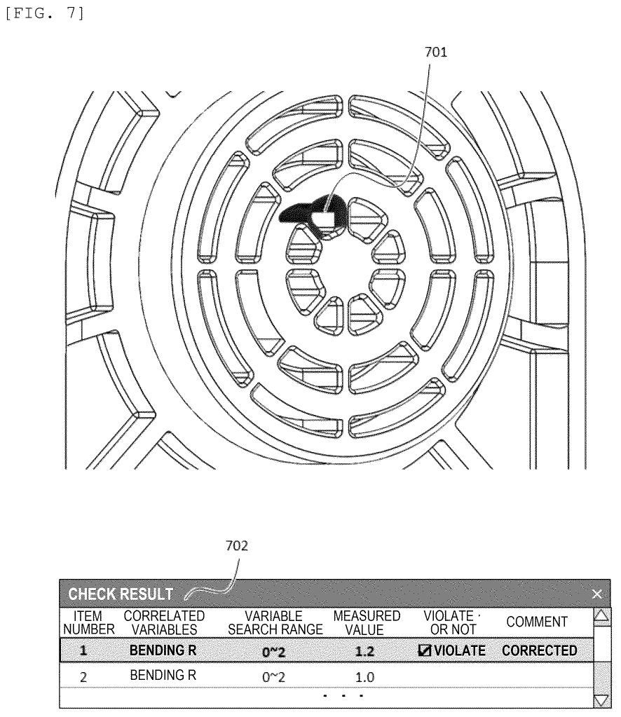

FIG. 7 is a diagram showing a shape and a position on the CAD model when the value of the bending R in the first embodiment is set to the outlier 602 of 1.2. Since each bending R and the position of each bending R are identified by the feature value identification unit 105, it is possible to automatically identify a violated portion 701 where the value of the bending R is 1.2. A check result list 702 may also be output together with the violated portion. The check result list 702 includes, for example, a check content, a measured value, a correction requirement, and a comment. By outputting the check result list 702, the user can more easily understand the violated portion in detail.

FIG. 8 is a diagram showing a shape and a position on the CAD model when the value of the bending R in the first embodiment is set to the outlier 602 of 1.0. In FIG. 8, a case in which the user determines that the outlier 602 does not correspond to a violated portion 801 will be described. The user checks non-requirement in a correction requirement field in the check result list 702. The check can be excluded from next and subsequent check targets. In addition, by selecting the correction requirement, it is possible to perform correction even when a portion that is not the violated portion is output as the violated portion.

### Second Embodiment

Next, in a second embodiment, an example of a frequency distribution calculation method and a violated portion identification method when the number of variables is two variables will be described. In the violated portion identification method according to the second embodiment, a user may partially intervene.

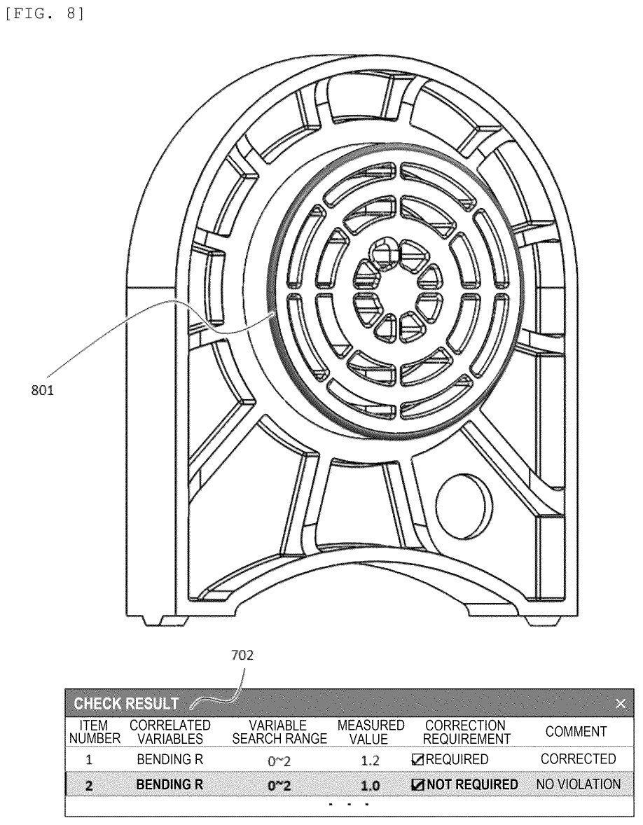

FIG. 9 is a diagram showing an example of an output setting screen according to the second embodiment. In the second embodiment, two variables of the wall thickness and the bending R are selected on the output variable selection screen 501. In the second embodiment, a scatter diagram is selected on the frequency distribution output selection screen 502. The scatter diagram is advantageous as a diagram showing the frequency distribution of two variables because the scatter diagram makes it easy to understand a tendency of correlation between two variables. As the diagram showing the frequency distribution of two variables, a diagram other than the scatter diagram may be used.

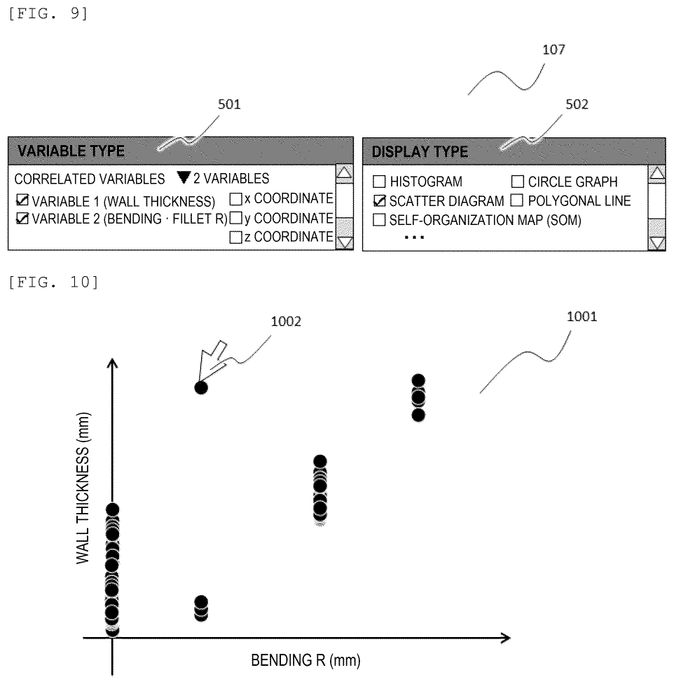

FIG. 10 is a diagram represented by a scatter diagram showing a relationship between the wall thicknesses and the bending R calculated by the frequency calculation unit 107 in the second embodiment. The feature value identification unit 105 identifies the wall thickness and the bending R on the CAD model and the positions thereof on the CAD model. The frequency calculation unit 107 calculates the wall thickness and the bending R on the CAD model using a wall thickness calculation function and a bending R calculation function of a geometric recognition function module of the geometric recognition function module storage unit 107.

As a result, it is possible to obtain a correlation scatter diagram 1001 between the wall thickness and the bending R. By the correlation scatter diagram 1001, it is possible to identify a thick portion different from other regions. Accordingly, even when the relationship between the wall thickness and the bending R is not uniquely determined, the violated portion can be checked on the CAD by calculating the frequency distribution of the wall thickness and the bending R. A threshold value may be set, and the outlier extraction unit 108 may automatically detect the outlier 1002.

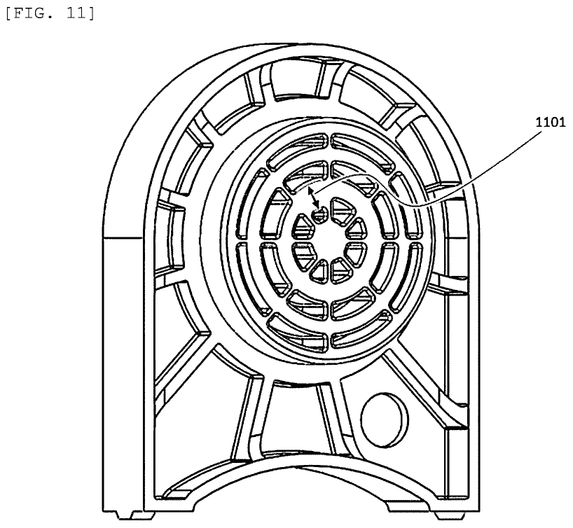

FIG. 11 is a diagram showing a shape and a position of the outlier 1002 on the CAD model in the second embodiment. Since each wall thickness and the position of each bending R are identified by the feature value identification unit 105, it is possible to identify a violated portion 1101 of the outlier 1002 in the scatter diagram 1001.

In this way, by obtaining the frequency distribution of two variables, it is possible to obtain a notice of a design error. In addition, even when the relationship between the bending R and the wall thickness is not uniquely determined, the violated portion can be checked on the CAD by obtaining the frequency distribution of each shape and position. Since the check can be performed on the CAD, the designer can notice the design error.

### Third Embodiment

In a third embodiment, an example of a frequency calculation method and a violated portion identification method when the number of variables is three variables or more will be described. In particular, in the third embodiment, it is checked whether there is a creation omission related to a positioning pin and a lot mark.

The lot mark is a mark for clarifying a manufacturing time of a component. The lot mark is used for management of a mold in resin molding and quality management of a molded resin component. Usually, in the same product, a position where the product is supported and a position where the lot mark is applied are approximately determined. Therefore, based on manufacturing performance data in the related art, it is checked whether there is an omission at a corresponding portion.

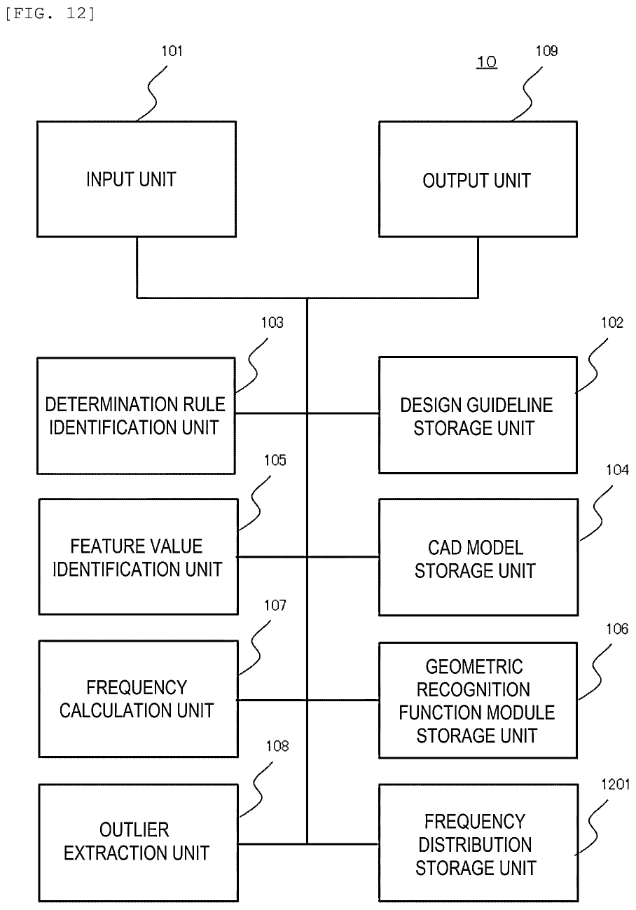

FIG. 12 is a diagram showing a configuration of the design support device 10 according to the third embodiment. A difference from the design support device 10 according to the first embodiment is that data in a frequency distribution of each variable from past performance data is stored in a frequency distribution storage unit 1201. By utilizing past data in the feature value identification unit 105, it is possible to reflect manufacturing performance. Further, the frequency distribution storage unit 1201 can grasp a complicated frequency distribution between multiple variables in advance.

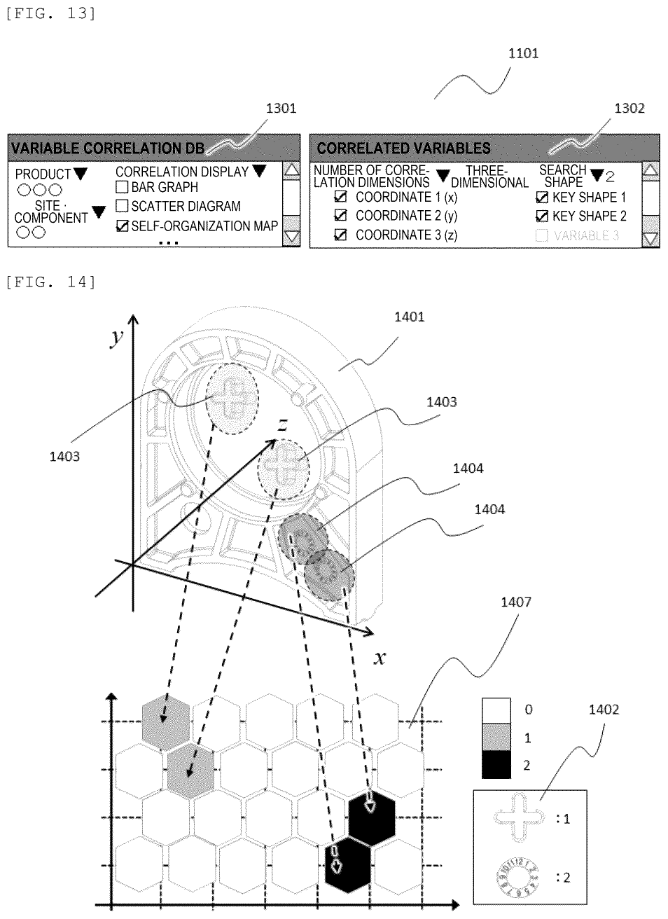

FIG. 13 is a diagram showing an example of an output setting screen according to the third embodiment. On a frequency selection screen 1301, a target product, a site of the product, and a method for displaying a frequency distribution are selected. Using the selection, the frequency distribution can be created with reference to the past performance data stored in the frequency distribution storage unit 1201. On the frequency selection screen 1301, a variable to be used for checking is selected from variables stored in the frequency distribution storage unit 1201 in advance. A frequency distribution to be output can be selected on a frequency distribution output selection screen 1302.

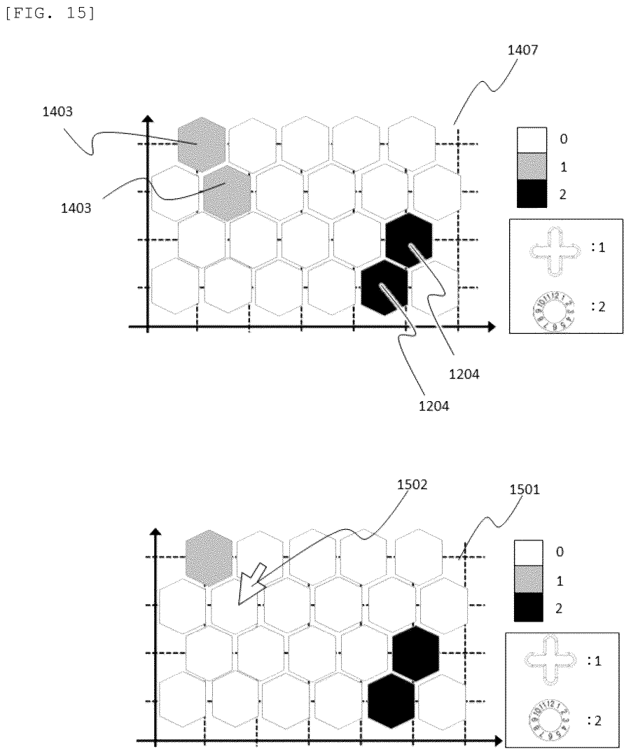

FIG. 14 is a diagram represented by a self-organization map showing a shape and a position of a CAD model calculated by the frequency calculation unit 107 with reference to the past performance data in the frequency distribution storage unit 1201. With reference to a past manufacturing performance CAD model 1401, the frequency calculation unit 107 automatically extracts whether two key shapes 1402 of the positioning pin and the lot mark exist at predetermined positions in x, y, and z coordinates.

In the third embodiment, when the frequency calculation unit 107 calculates positioning of the positioning pin and the lot mark, a similar shape search function is used from among the common functions stored in the geometric recognition function module storage unit 106. The similar shape search function is a function for automatically searching for a shape similar to the key shape from a geometric feature value and a positional feature value.

Since existence regions 1403 of the positioning pin and existence regions 1404 of the lot mark are on three-dimensional coordinates, it is difficult to visually recognize a difference when the existence region 1403 of the positioning pin and the existence region 1404 of the lot mark are compared with frequency correlation accumulated in the frequency distribution storage unit 1201. Therefore, in the frequency distribution of the key shape and the position stored in the frequency distribution storage unit 1201, a self-organization map (SOM) 1407 that compresses three-dimensional coordinates into two-dimensional coordinates is applied. By using the self-organization map 1407, multi-dimensional data can be compressed two-dimensionally, and correlation of multiple variables can be visually grasped. In the third embodiment, the self-organization map 1407 is used, and the invention is not limited thereto. As another method, for example, machine learning such as a neural network or an autoencoder may be used.

In the third embodiment, the frequency calculation unit 107 sets the value to 1 when searching for the key shape of the positioning pin, and sets the value to 2 when searching for the key shape of the lot mark. Values of other regions are set to 0. A color is applied for each value, and a result is shown on the self-organization map. The color applied on the self-organization map makes it easier to grasp which component exists at which position.

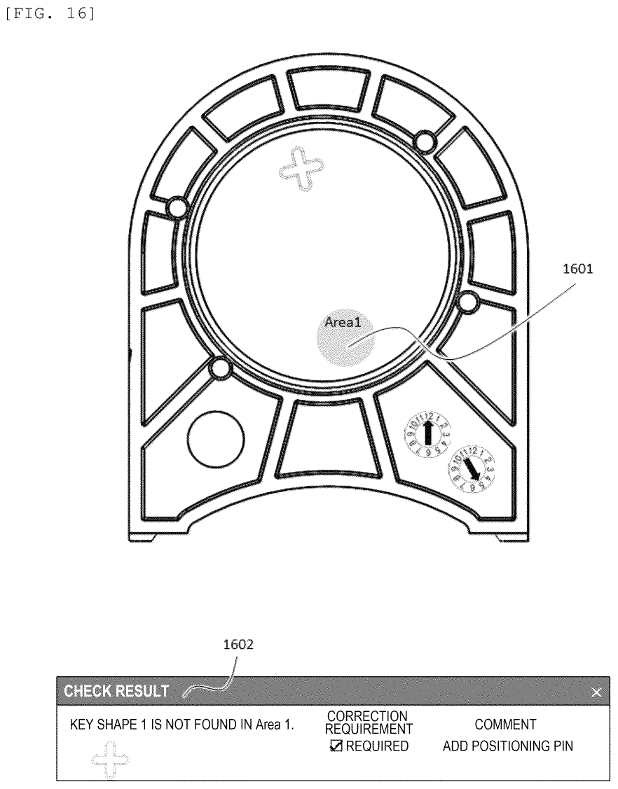

FIG. 15 is a diagram showing a result of the outlier extraction unit 108 when the frequency distribution storage unit 1201 is used. A frequency distribution 1407 of the key shape and the position of the key shape stored in the frequency distribution storage unit 1201 for the CAD model to be checked is compared with a frequency distribution 1501 of the key shape and the position of the key shape mapped on the self-organization map for the CAD model to be checked. In the comparison, the outlier extraction unit 108 selects, as an outlier, the portion 1502 that exists in the frequency distribution 1407 but does not exist in the frequency distribution 1501.

That is, the outlier extraction unit 108 sets the presence or absence of the shape at each position in the frequency distribution 1407 as a threshold value, and extracts the outlier based on the presence or absence of the shape at each position in the frequency distribution 1501. The designer may compare the frequency distribution 1407 with the frequency distribution 1501 and select the outlier.

FIG. 16 is a diagram in which the outlier extraction unit 108 identifies a portion as an outlier. Here, a portion 1601 as an outlier of the key shape selected in FIG. 15 is output. In addition, a check result list 1602 indicates that there is no key shape meaning a positioning pin as a violation content of the key shape. Therefore, the invention can be applied to a check for a shape creation omission.

Finally, a design support method for the present disclosure will be described.

In an embodiment of the invention, an input unit inputs a feature value including a shape and a position of a CAD model, a feature value identification unit identifies the shape and the position on the CAD model using the feature value received from the input unit, a frequency calculation unit calculates a frequency distribution at the shape and the position identified by the feature value identification unit, and an output unit outputs the frequency distribution calculated by the frequency calculation unit.

The disclosure is not limited to the above-described embodiments, and includes various modifications. The embodiments described above are described in detail to facilitate understanding of the disclosure, and the disclosure is not necessarily limited to those including all the described configurations. A part of a configuration in one embodiment can be replaced with a configuration in another embodiment, and a configuration in one embodiment can also be added to a configuration in another embodiment. A part of a configuration in each embodiment can also be added to, deleted from, or replaced with another configuration.

A part or all of configurations, functions, processing units, processing methods, and the like described above may be implemented by hardware such as an integrated circuit. In addition, the configurations, functions, and the like described above may be implemented by software by a processor interpreting and executing a program for implementing each function. Information such as a program, a table, and a file for implementing each function can be stored in a recording device such as a memory, a hard disk, and a solid state drive (SSD), or in a recording medium such as a flash memory card and a digital versatile disk (DVD).

Control lines and information lines considered to be necessary for description are shown in each embodiment described above, and not all control lines and information lines in a product are necessarily shown. Actually, almost all components may be considered to be connected to one another.

### REFERENCE SIGNS LIST

10: design support device
101: input unit
102: design guideline storage unit
103: determination rule identification unit
104: CAD model storage unit
105: feature value identification unit
106: geometric recognition function module storage unit
107: frequency calculation unit
108: outlier extraction unit
109: output unit

1. A design support device that supports design of a CAD model, the design support device comprising:
an input unit configured to input the CAD model and a feature value including a shape and a position of the CAD model;
a feature value identification unit configured to identify the shape and the position on the CAD model using the feature value received from the input unit;
a frequency calculation unit configured to calculate a frequency distribution of the feature value including the shape and the position identified by the feature value identification unit; and
an output unit configured to output the frequency distribution calculated by the frequency calculation unit.

2. The design support device according to claim 1, further comprising:
an outlier extraction unit configured to extract an outlier from the frequency of the shape and the position of the CAD model calculated by the frequency calculation unit, wherein
the outlier is a candidate of a portion unsuitable for the CAD model.

3. The design support device according to claim 2, wherein
the outlier extraction unit provides a threshold value for the frequency related to the shape and the position of the CAD model, and
the threshold value is a boundary value indicating whether the value is the outlier.

4. The design support device according to claim 2, further comprising:
a frequency distribution storage unit configured to store a frequency distribution of a shape and a position of a CAD model designed previously, wherein the outlier extraction unit compares the frequency distribution stored in the frequency distribution storage unit with the frequency distribution calculated by the frequency calculation unit, and extracts the outlier.

5. The design support device according to claim 2, wherein the output unit emphatically indicates a shape and a position of the outlier extracted by the outlier extraction unit on the CAD model.

6. The design support device according to claim 1, wherein
the output unit outputs the frequency distribution using a histogram, a scatter diagram, or a self-organization map.

7. The design support device according to claim 1, wherein
the shape is a dimension of each portion of the CAD model.

8. The design support device according to claim 1, wherein
the position is a coordinate position in the CAD model.

9. A design support apparatus comprising:
the design support device according to claim 1; and
a display unit configured to display a setting screen for inputting to the input unit and the frequency distribution output by the output unit.

10. A design support method for supporting design of a CAD model, the design support method comprising:
inputting, by an input unit, the CAD model and a feature value including a shape and a position of the CAD model;
identifying, by a feature value identification unit, the shape and the position on the CAD model using the feature value received from the input unit;
calculating, by a frequency calculation unit, a frequency distribution of the shape and the position identified by the feature value identification unit; and
outputting, by an output unit, the frequency distribution calculated by the frequency calculation unit.

11. The design support method according to claim 10, further comprising:
extracting, by an outlier extraction unit, an outlier from the frequency distribution of the shape and position of the CAD model calculated by the frequency calculation unit.

12. The design support method according to claim 11, wherein
the outlier extraction unit provides a threshold value related to the frequency of the shape and the position of the CAD model.

13. The design support method according to claim 11, further comprising:
storing, by a frequency distribution storage unit, a frequency distribution of a shape and a position of a CAD model designed previously, wherein
the outlier extraction unit compares the frequency distribution stored in the frequency distribution storage unit with the frequency distribution calculated by the frequency calculation unit, and extracts the outlier.

14. The design support method according to claim 11, wherein
the output unit emphatically indicates a shape and a position of the outlier extracted by the outlier extraction unit on the CAD model.
